(19) United States
(12) Patent Application Publication
(10) Pub. No.: US 2007/0208107 A1
(43) Pub. Date: Sep. 6, 2007

(54) Additive building material mixtures containing microparticles swollen in the building material mixture

(75) Inventors: Jan Hendrik Schattka, Hanau (DE); Thorsten Goldacker, Rossdorf (DE); Holger Kautz, Hanau (DE); Gerd Lohden, Hanau (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GBMH & CO. KG, Darmstadt (DE)

(21) Appl. No.: 11/387,977

(22) Filed: Mar. 24, 2006

(30) Foreign Application Priority Data
Mar. 1, 2006 (DE) 10 2006 009 842.0

(51) Int. Cl. C04B 24/26; C08K 9/00

(52) U.S. Cl. 523/200; 524/2

(57) ABSTRACT

The present invention relates to the use of polymeric microparticles in hydraulically setting building material mixtures for the purpose of enhancing their frost resistance and cyclical freeze/thaw durability.

The present invention relates to the use of polymeric microparticles in hydraulically setting building material mixtures for the purpose of enhancing their frost resistance and cyclical freeze/thaw durability.

Decisive factors affecting the resistance of concrete to frost and to cyclical freeze/thaw under simultaneous exposure to thawing agents are the imperviousness of its microstructure, a certain strength of the matrix, and the presence of a certain pore microstructure. The microstructure of a cement-bound concrete is traversed by capillary pores (radius: 2 μm-2 mm) and gel pores (radius: 2-50 nm). Water present in these pores differs in its state as a function of the pore diameter. Whereas water in the capillary pores retains its usual properties, that in the gel pores is classified as condensed water (mesopores: 50 nm) and adsorptively bound surface water (micropores: 2 nm), the freezing points of which may for example be well below −50° C. [M. J. Setzer, Interaction of water with hardened cement paste, Ceramic Transactions 16 (1991) 415-39]. Consequently, even when the concrete is cooled to low temperatures, some of the water in the pores remains unfrozen (metastable water). For a given temperature, however, the vapor pressure over ice is lower than that over water. Since ice and metastable water are present alongside one another simultaneously, a vapor-pressure gradient develops which leads to diffusion of the still-liquid water to the ice and to the formation of ice from said water, resulting in removal of water from the smaller pores or accumulation of ice in the larger pores. This redistribution of water as a result of cooling takes place in every porous system and is critically dependent on the type of pore distribution.

The artificial introduction of microfine air pores in the concrete hence gives rise primarily to what are called expansion spaces for expanding ice and ice-water. Within these pores, freezing water can expand or internal pressure and stresses of ice and ice-water can be absorbed without formation of microcracks and hence without frost damage to the concrete. The fundamental way in which such air-pore systems act has been described, in connection with the mechanism of frost damage to concrete, in a large number of reviews [Schulson, Erland M. (1998) Ice damage to concrete. CRREL Special Report 98-6; S. Chatterji, Freezing of air-entrained cement-based materials and specific actions of air-entraining agents, Cement & Concrete Composites 25 (2003) 759-65; G. W. Scherer, J. Chen & J. Valenza, Methods for protecting concrete from freeze damage, U.S. Pat. No. 6,485,560 B1 (2002); M. Pigeon, B. Zuber & J. Marchand, Freeze/thaw resistance, Advanced Concrete Technology 2 (2003) 11/1-11/17; B. Erlin & B. Mather, A new process by which cyclic freezing can damage concrete—the Erlin/Mather effect, Cement & Concrete Research 35 (2005) 1407-11].

A precondition for improved resistance of the concrete on exposure to the freezing and thawing cycle is that the distance of each point in the hardened cement from the next artificial air pore does not exceed a defined value. This distance is also referred to as the “Powers spacing factor” [T. C. Powers, The air requirement of frost-resistant concrete, Proceedings of the Highway Research Board 29 (1949) 184-202]. Laboratory tests have shown that exceeding the critical “Power spacing factor” of 500 μm leads to damage to the concrete in the freezing and thawing cycle. In order to achieve this with a limited air-pore content, the diameter of the artificially introduced air pores must therefore be less than 200-300 μm [K. Snyder, K. Natesaiyer & K. Hover, The stereological and statistical properties of entrained air voids in concrete: A mathematical basis for air void systems characterization, Materials Science of Concrete VI (2001) 129-214].

The formation of an artificial air-pore system depends critically on the composition and the conformity of the aggregates, the type and amount of the cement, the consistency of the concrete, the mixer used, the mixing time, and the temperature, but also on the nature and amount of the agent that forms the air pores, the air entrainer. Although these influencing factors can be controlled if account is taken of appropriate production rules, there may nevertheless be a multiplicity of unwanted adverse effects, resulting ultimately in the concrete's air content being above or below the desired level and hence adversely affecting the strength or the frost resistance of the concrete.

Artificial air pores of this kind cannot be metered directly; instead, the air entrained by mixing is stabilized by the addition of the aforementioned air entrainers [L. Du & K. J. Folliard, Mechanism of air entrainment in concrete, Cement & Concrete Research 35 (2005) 1463-71]. Conventional air entrainers are mostly surfactant-like in structure and break up the air introduced by mixing into small air bubbles having a diameter as far as possible of less than 300 μm, and stabilize them in the wet concrete microstructure. A distinction is made here between two types.

One type—for example sodium oleate, the sodium salt of abietic acid or Vinsol resin, an extract from pine roots—reacts with the calcium hydroxide of the pore solution in the cement paste and is precipitated as insoluble calcium salt. These hydrophobic salts reduce the surface tension of the water and collect at the interface between cement particle, air and water. They stabilize the microbubbles and are therefore encountered at the surfaces of these air pores in the concrete as it hardens.

The other type—for example sodium lauryl sulfate (SDS) or sodium dodecyl-phenylsulfonate—reacts with calcium hydroxide to form calcium salts which, in contrast, are soluble, but which exhibit an abnormal solution behavior. Below a certain critical temperature the solubility of these surfactants is very low, while above this temperature their solubility is very good. As a result of preferential accumulation at the air/water boundary they likewise reduce the surface tension, thus stabilize the microbubbles, and are preferably encountered at the surfaces of these air pores in the hardened concrete.

The use of these prior-art air entrainers is accompanied by a host of problems [L. Du & K. J. Folliard, Mechanism of air entrainment in concrete, Cement & Concrete Research 35 (2005) 1463-71]. For example, prolonged mixing times, different mixer speeds and altered metering sequences in the case of ready-mix concretes result in the expulsion of the stabilized air (in the air pores).

The transporting of concretes with extended transport times, poor temperature control and different pumping and conveying equipment, and also the introduction of these concretes in conjunction with altered subsequent processing, jerking and temperature conditions, can produce a significant change in an air-pore content set beforehand. In the worst case this may mean that a concrete no longer complies with the required limiting values of a certain exposure class and has therefore become unusable [EN 206-1 (2000), Concrete—Part 1: Specification, performance, production and conformity].

The amount of fine substances in the concrete (e.g. cement with different alkali content, additions such as flyash, silica dust or color additions) likewise adversely affects air entrainment. There may also be interactions with flow improvers that have a defoaming action and hence expel air pores, but may also introduce them in an uncontrolled manner.

All of these influences which complicate the production of frost-resistant concrete can be avoided if, instead of the required air-pore system being generated by means of abovementioned air entrainers with surfactant-like structure, the air content is brought about by the admixing or solid metering of polymeric microparticles (hollow microspheres) [H. Sommer, A new method of making concrete resistant to frost and de-icing salts, Betonwerk & Fertigteiltechnik 9 (1978) 476-84]. Since the microparticles generally have particle sizes of less than 100 μm, they can also be distributed more finely and uniformly in the concrete microstructure than can artificially introduced air pores. Consequently, even small amounts are sufficient for sufficient resistance of the concrete to the freezing and thawing cycle.

The use of polymeric microparticles of this kind for improving the frost resistance and cyclical freeze/thaw durability of concrete is already known from the prior art [cf. DE 2229094 A1, U.S. Pat. No. 4,057,526 B1, U.S. Pat. No. 4,082,562 B1, DE 3026719 A1]. The microparticles described therein are notable in particular for the fact that they possess a void which is smaller than 200 μm (diameter), and this hollow core consists of air (or a gaseous substance). This likewise includes porous microparticles on the 100 μm scale, which may possess a multiplicity of relatively small voids and/or pores.

With the use of hollow microparticles for artificial air entrainment in concrete, two factors proved to be disadvantageous for the implementation of this technology on the market. On the one hand the preparation costs of hollow microspheres in accordance with the prior art are too high, and on the other relatively high doses are required in order to achieve satisfactory resistance of the concrete to freezing and thawing cycles.

The object on which the present invention is based was therefore that of providing a means of improving the frost resistance and cyclical freeze/thaw durability for hydraulically setting building material mixtures that develops its full activity even in relatively low doses. A further object was not, or not substantially, to impair the mechanical strength of the building material mixture as a result of said means.

These and also further objects, not identified explicitly yet readily derivable or comprehensible from the circumstances discussed herein in the introduction, are achieved by core/shell microparticles which possess a base-swellable core and whose shell is composed of polymers having a glass transition temperature of below 50° C.; preference is given to glass transition temperatures of less than 30° C.; particular preference is given to glass transition temperatures of less than 15° C.; the most preference is given to glass transition temperatures of less than 5° C.

The particles of the invention are prepared preferably by emulsion polymerization.

It has been found that the particles of the invention are suitable for producing, even added in very small amounts, effective resistance towards frost cycling and freeze/thaw cycling.

In one particularly preferred embodiment of the invention the unswollen core/shell particles are added to the building material mixture, and they swell in the strongly alkaline mixture and so form the cavity ‘in situ’, as it were.

Also in accordance with the invention is a process for preparing a building material mixture which involves mixing swellable but as yet unswollen core/shell particles with the typical components of a building material mixture and the swelling of the particles taking place only in the building material mixture.

According to one preferred embodiment the microparticles used are composed of polymer particles which possess a core (A) and at least one shell (B), the core/shell polymer particles having been swollen by means of a base.

The preparation of these polymeric microparticles by emulsion polymerization and their swelling using bases such as alkali or alkali metal hydroxides and also ammonia and amine, for example, are described in European patents EP 22 633 B1, EP 735 29 B1 and EP 188 325 B1.

The core (A) of the particle contains one or more ethylenically unsaturated carboxylic acid (derivative) monomers which permit swelling of the core; these monomers are preferably selected from the group of acrylic acid, methacrylic acid, maleic acid, maleic anhydride, fumaric acid, itaconic acid and crotonic acid and mixtures thereof. Acrylic acid and methacrylic acid are particularly preferred.

In one particular embodiment of the invention the polymers that form the core may also be crosslinked. The amounts of crosslinker employed with preference are 0-10% by weight (relative to the total amount of monomers in the core); preference is further given to 0-6% by weight of crosslinker; the most preferred are 0-3% by weight. In any case, the amount of the crosslinker must be selected such that swelling is not completely prevented.

Examples that may be mentioned of suitable crosslinkers include ethylene glycol di(meth)acrylate, propylene glycol di(meth)acrylate, allyl(meth)acrylate, divinylbenzene, diallyl maleate, trimethylolpropane trimethacrylate, glycerol di(meth)acrylate, glycerol tri(meth)acrylate, pentaerythritol tetra(meth)acrylate or mixtures thereof.

The (meth)acrylate notation here denotes not only methacrylate, such as methyl methacrylate, ethyl methacrylate, etc., but also acrylate, such as methyl acrylate, ethyl acrylate, etc., and also mixtures of both.

The shell (B) is composed predominantly of nonionic, ethylenically unsaturated monomers. As monomers of this kind it is preferred to use styrene, butadiene, vinyltoluene, ethylene, vinyl acetate, vinyl chloride, vinylidene chloride, acrylonitrile, acrylamide, methacrylamide and/or C1-C12 alkyl esters of (meth)acrylic acid or mixtures thereof.

When selecting the monomers it is necessary in accordance with the invention to ensure that the glass transition temperature of the resulting copolymer is less than 50° C.; preferably the glass transition temperature is less than 30° C., particular preference being given to glass transition temperatures of less than 15° C.; the most preferable are glass transition temperatures of less than 5° C.

The glass transition temperature is calculated in this case appropriately with the aid of the Fox equation.

The Fox equation refers in this specification to the following formula, which is known to the skilled worker:

$$\frac{1}{Tg ( P )} = \frac{a}{Tg ( A )} + \frac{b}{Tg ( B )} + \frac{c}{Tg ( C )} + …$$

In this formula Tg(P) designates the glass transition temperature to be calculated for the copolymer, in degrees Kelvin. Tg(A), Tg(B), Tg(C), etc. designate the respective glass transition temperatures (in degrees Kelvin) of the high molecular mass homopolymers of the monomers A, B, C, etc., measured by dynamic heat-flow differential calorimetry (Dynamic Scanning Calorimetry, DSC).

(Tg values for homopolymers are listed inter alia in, for example, Polymer Handbook, Johannes Brandrup, Edmund H. Immergut, Eric A. Grulke; John Wiley & Sons, New York (1999)).

The Fox equation has become established for the estimation of the glass transition temperature, even though under certain conditions there may be deviations from values measured.

For a more precise determination of the glass transition temperature it is possible to prepare the shell polymer separately; the glass transition temperature can then be measured with the aid of DSC (read off from the second heating curve, heating or cooling raterate 10 K/min).

In addition to the abovementioned monomers it is possible for the polymer envelope (B) to contain monomers, which enhances the permeability of the shell for bases—and here, especially, ionic bases. These may be, on the one hand, acid-containing monomers such as acrylic acid, methacrylic acid, maleic acid, maleic anhydride, fumaric acid, monoesters of fumaric acid, itaconic acid, crotonic acid, maleic acid, monoesters of maleic acid, acrylamidoglycolic acid, methacrylamidobenzoic acid, cinnamic acid, vinylacetic acid, trichloroacrylic acid, 10-hydroxy-2-decenoic acid, 4-methacryloyloxyethyltrimethylic acid, styrenecarboxylic acid, 2-(isopropenylcarbonyloxy)ethanesulfonic acid, 2-(vinylcarbonyloxy)ethanesulfonic acid, 2-(isopropenylcarbonyloxy)propylsulfonic acid, 2-(vinylcarbonyloxy)propylsulfonic acid, 2-acrylamido-2-methylpropanesulfonic acid, acrylamidododecanesulfonic acid, 2-propene-1-sulfonic acid, methallylsulfonic acid, styrenesulfonic acid, styrenedisulfonic acid, methacrylamidoethanephosphonic acid, vinylphosphonic acid, and mixtures thereof. On the other hand it is also possible for the permeability to be enhanced by means of hydrophilic, nonionic monomers, of which mention should be made here, as examples, of acrylonitrile, (meth)acrylamide, cyano-methyl methacrylate, N-vinylamides, N-vinylformamides, N-vinylacetamides, N-vinyl-N-methylacetamides, N-vinyl-N-methylformamides, N-methylol(meth)acrylamide, vinylpyrrolidone, N,N-dimethylpropylacrylamide, dimethyl-acrylamide, and also other hydroxyl-, amino-, amido- and/or cyano-containing monomers, and mixtures thereof.

A restriction of these or other monomers not specified at this point exists only by virtue of the fact that the glass transition temperatures according to the invention are not exceeded and the monomer mixture ought not to stand in the way of the preparation and the ordered construction of the article.

Hydrophilic and acid-containing monomers together typically account for not more than 30% by weight (relative to the total monomer mixture of the shell) of the composition of the polymer envelope (B); particular preference is given to amounts between 0.2% and 20% by weight, the most preference to amounts between 0.5% and 10% by weight.

In a further preferred embodiment the monomer composition of the core and of the shell does not change with a sharp discontinuity, as is the case for a core/shell particle of ideal construction, but instead changes gradually in two or more steps or in the form of a gradient.

Where the microparticles are constructed as multishell particles, the composition of the shells lying between core and outer shell is often oriented on the shells adjacent to either side, which means that the amount of a monomer Mx in general between the amount M(x+1) in the next-outer shell (which may also be the outer shell) and the amount M(x−1) in the next-inner shell (or the core). This is not mandatory, however, and in further particular embodiments the compositions of such intermediate shells may also be selected freely, provided it does not stand in the way of the preparation and the ordered construction of the particle.

The shell B of the particles of the invention accounts for preferably 10% to 96% by weight of the total weight of the particle, particular preference being given to shell fractions of 20% to 94% by weight. The most preferred are shell fractions of 30% to 92% by weight.

In the case of very thin shells this may lead to the shells of the particles bursting on swelling. It has been found, however, that this does not automatically result in the effect of these particles being lost. In particular embodiments of the invention, and especially when swelling takes place in the building material mixture, this effect may be advantageous, since without the restriction of the shell it is possible for better swelling of the particles to take place.

Where the microparticles are swollen only in the building mixture itself, it is possible to prepare dispersions having significantly higher solids contents (i.e. weight fractions of polymer relative to total weight of the dispersion), since the volume occupied by the unswollen particles is of course smaller than that of the swollen particles.

The polymer particles can also be initially swollen with a small amount of base, and can be added in this partly swollen state to the building material mixture. This corresponds, then, to a compromise, since a somewhat lower raising of the solids content is still always possible, while on the other hand the time which is provided for swelling in the building material mixture can be made shorter.

The polymer content of the microparticles used may be, depending on diameter and on water content, 2% to 98% by weight (weight of polymer relative to the total weight of the water-filled particle).

Preference is given to polymer contents of 5% to 60% by weight, particular preference to polymer contents of 10% to 40% by weight.

The microparticles of the invention can be prepared preferably by emulsion polymerization and preferably have an average particle size of 100 to 5000 nm; particular preference is given to an average particle size of 200 to 2000 nm. The most preferred are average particle sizes of 250 to 1000 nm.

The average particle size is determined by means for example of counting a statistically significant amount of particles, using transmission electron micrographs.

In the case of preparation by emulsion polymerization the microparticles are obtained in the form of an aqueous dispersion. Accordingly, the addition of the microparticles to the building material mixture takes place preferably likewise in this form.

Within the scope of the present invention it is also readily possible, however, to add the water-filled microparticles directly as a solid to the building material mixture. For that purpose the microparticles are, for example, coagulated and isolated from the aqueous dispersion by standard methods (e.g. filtration, centrifugation, sedimentation and decanting) and the particles are subsequently dried.

If addition in solid form is desired or necessary for technical reasons associated with processing, then further preferred methods of drying are spray drying and freeze drying.

The water-filled microparticles are added to the building material mixture in a preferred amount of 0.01% to 5% by volume, in particular 0.1% to 0.5% by volume. The building material mixture, in the form for example of concrete or mortar, may in this case include the customary hydraulically setting binders, such as cement, lime, gypsum or anhydrite, for example.

A substantial advantage through the use of the water-filled microparticles is that only an extremely small amount of air is introduced into the concrete. As a result, significantly improved compressive strengths are achievable in the concrete. These are about 25%-50% above the compressive strengths of concrete obtained with conventional air entrainment. Hence it is possible to attain strength classes which can otherwise be set only by means of a substantially lower water/cement value (w/c value). Low w/c values, however, in turn significantly restrict the processing properties of the concrete in certain circumstances.

Moreover, higher compressive strengths may result in it being possible to reduce the cement content of the concrete that is needed for strength to develop, and hence a significant reduction in the price per m³ of concrete.

1. Use of polymeric core/shell microparticles in hydraulically setting building material mixtures, characterized in that they possess a core that can be swollen by bases, and in that their shell is composed of polymers having a glass transition temperature of below 50° C.

2. Use of polymeric core/shell microparticles in hydraulically setting building material mixtures, according to claim 1, characterized in that their shell is composed of polymers having a glass transition temperature of below 30° C.

3. Use of polymeric core/shell microparticles according to claim 1, characterized in that the core is swollen before the particles are added to the building material mixture.

4. Use of polymeric core/shell microparticles according to claim 1, characterized in that the core is swollen ‘in situ’ in the alkali medium of the building material mixture.

5. Use of polymeric core/shell microparticles according to claim 1, characterized in that the microparticles are composed of polymer particles which comprise a polymer core (A), which is swollen or swellable by means of an aqueous base and contains one or more unsaturated carboxylic acid (derivative) monomers, and a polymer envelope (B), which is composed predominantly of nonionic, ethylenically unsaturated monomers.

6. Use of polymeric core/shell microparticles according to claim 5, characterized in that the nonionic, ethylenically unsaturated monomers of the shell are composed of styrene, butadiene, vinyltoluene, ethylene, vinyl acetate, vinyl chloride, vinylidene chloride, acrylonitrile, acrylamide, methacrylamide and/or C1-C12 alkyl esters of acrylic or methacrylic acid.

7. Use of polymeric core/shell microparticles according to claim 5, characterized in that the unsaturated carboxylic acid (derivative) monomers of the core (A) are selected from the group of acrylic acid, methacrylic acid, maleic acid, maleic anhydride, fumaric acid, itaconic acid and crotonic acid.

8. Use of polymeric core/shell microparticles according to claim 1, characterized in that the microparticles have a polymer content of 2% to 98% by weight.

9. Use of polymeric core/shell microparticles according to claim 1, characterized in that the shell (B) accounts for 10% to 96% by weight of the total weight of the particle.

10. Use of polymeric core/shell microparticles according to claim 1, characterized in that the microparticles have an average particle size of 100 to 5000 nm.

11. Use of polymeric core/shell microparticles according to claim 10, characterized in that the microparticles have an average particle size of 200 to 2000 nm.

12. Use of polymeric core/shell microparticles according to claim 11, characterized in that the microparticles have an average particle size of 250 to 1000 nm.

13. Use of polymeric core/shell microparticles according to claim 1, characterized in that the microparticles are used in an amount of 0.01% to 5% by volume, based on the building material mixture.

14. Use of polymeric core/shell microparticles according to claim 13, characterized in that the microparticles are used in an amount of 0.1% to 0.5% by volume, based on the building material mixture.

15. Use of polymeric core/shell microparticles according to claim 1, characterized in that the building material mixtures are composed of a binder selected from the group of cement, lime, gypsum and anhydrite.

16. Use of polymeric core/shell microparticles according to claim 1, characterized in that the building material mixtures are concrete or mortar.

17. A process for preparing a building material mixture which after hardening is resistant to frost and to cyclical freeze/thaw, characterized in that swellable but unswollen core/shell particles are mixed with the remaining components of the building material mixture, wherein the swelling of the particles takes place in the building material mixture itself.
